(19) United States
(12) Patent Application Publication
(10) Pub. No.: US 2015/0339387 A1
(43) Pub. Date: Nov. 26, 2015

(54) METHOD OF AND SYSTEM FOR FURNISHING A USER OF A CLIENT DEVICE WITH A NETWORK RESOURCE

(71) Applicant: YANDEX EUROPE AG, Luzern (CH)

(72) Inventors: Alexey Andreevich DOTSENKO, Moscow (RU); Tigran Oganesovich KHUDAVERDYAN, Moscow (RU); Dmitry Gennadievich GORBATKOV, Moscow (RU)

(21) Appl. No.: 14/655,890

(22) PCT Filed: Dec. 27, 2013
(86) PCT No.: PCT/IB13/61379

§ 371 Date: Jun. 26, 2015

(30) Foreign Application Priority Data
Dec. 26, 2012 (RU) PCT/RU2012/001087

(51) Int. Cl. G06F 17/30; G06F 3/0484

(52) U.S. Cl. CPC G06F 17/30864; G06F 3/04847; G06F 3/04842; G06F 17/30887

(57) ABSTRACT

Furnishing a user of a client device having a user interface with a display displaying search bar, with a network resource, comprising: Receiving, by a server from the client device, a portion a search term having been entered in the search bar. Sending, by the server to the client device, identification of a network resource associated with the portion of the search term. Receiving, by the server from the client device, a request to furnish the client device with the network resource associated with the portion of the search term. Sending, by the server to the client device, the network resource associated with the portion of the search term. All prior to the user having requested a search in respect of the portion of the search term.

### CROSS-REFERENCE

The present application claims priority to International Patent Application No. PCT/RU2012/001087, filed Dec. 26, 2012, entitled “Method of and System for Furnishing a User of a Client Device with a Network Resource.” That application is incorporated herein by reference in its entirety.

### FIELD

The present specification relates to methods of and systems for furnishing a user of a client device with a network resource.

### BACKGROUND

The Internet provides access to a wide variety of network resources, for example, video files, image files, audio files, or Web pages, including content for particular subjects, book articles, or news articles. A search engine can select one or more resources in response to receiving a search query. A search query is data that a user submits to (or causes, knowingly or unknowingly, to be submitted to or obtained by) a search engine to conduct a search to satisfy the user's informational needs. Search queries almost always include data in the form of text—e.g., one or more search query terms—as well as other information. The search engine selects and scores resources based on their relevance to the search query and on their importance relative to other resources to provide search results that link to the selected resources. The search results are typically ordered according to the scores and presented according to this order.

Given the volume of information available via the Internet, and the lack of consistency between various resources, it is not always easy for a user to formulate search query terms that will quickly and easily provide them with the information that they seek. To assist users, search engines can provide search query suggestions to users to help users satisfy their informational needs—i.e. search engines can suggest query terms that could be used to refine a search or refine a search strategy so as to yield more pertinent results. Some search engines provide search query suggestions in the form of a list of search query suggestions in a drop-down box as the user is typing in query term(s). The user can then select one of the search query suggestions from the list without having to type all of the entire search query term(s).

Typically, in operation the user's client device sends the elements of a search query (including search query term(s)—which may be letters, numbers or characters—i.e. text) to the search engine with each keystroke, and the search engine provides the query suggestions with prefixes that match the entered text prior to the receipt of a search result request. Once the search query suggestions have been received by the client device, the client device displays these suggestions for user selection in the drop-down box. Typically one of the search query suggestions is highlighted and should the user hit the enter button on their device, it is that highlighted search query that will be entered. If the user does not hit enter on their device, as the user types in additional information via further keystrokes, the search engine system attempts to provide the user more refined search query suggestion choices.

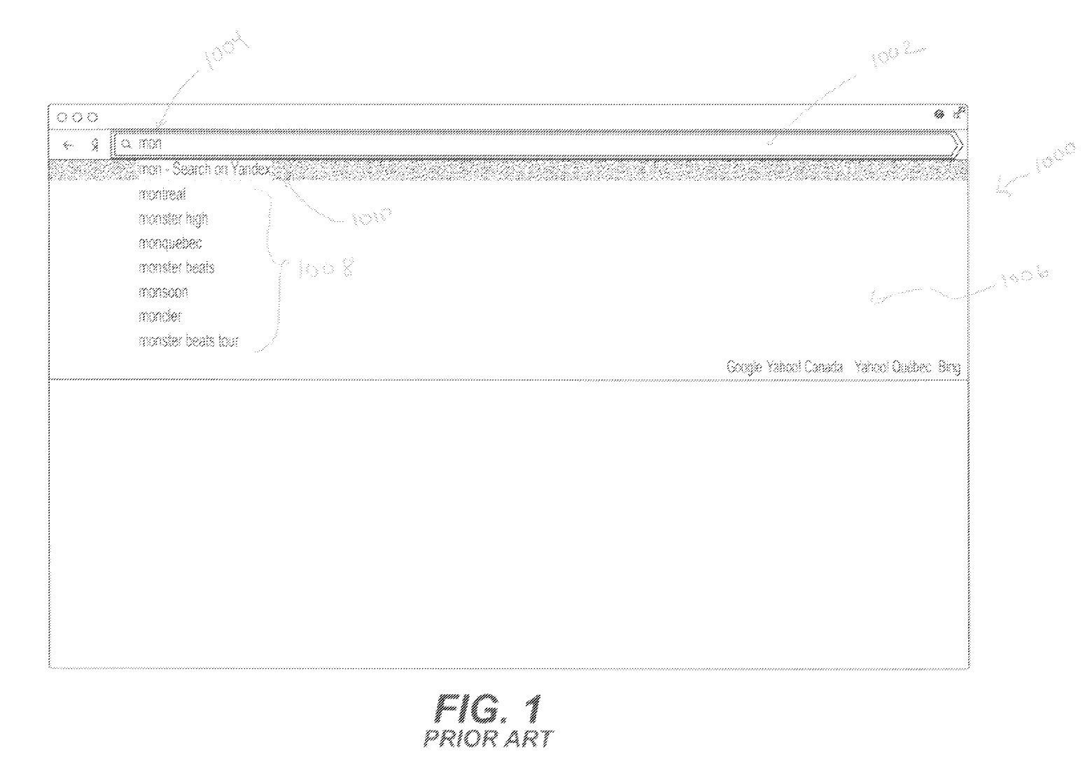

In this respect, FIG. 1 shows a browser window 1000 showing on operation of one example of a conventional prior art search engine query suggestion system. In FIG. 1, the user has entered into the “omnibar” 1002 of the browser 1000 (being a multi-function bar including the function of a search bar) the letters “MON” 1004. The search engine query suggestion system has returned, and the browser 1000 is displaying in a drop-down box 1006 associated with the omnibar 1002, several suggested search queries 1008 based on the search term MON 1004 (in addition to providing the user with the choice 1010 of conducting a search including the search term “MON” in the Yandex™ search engine).

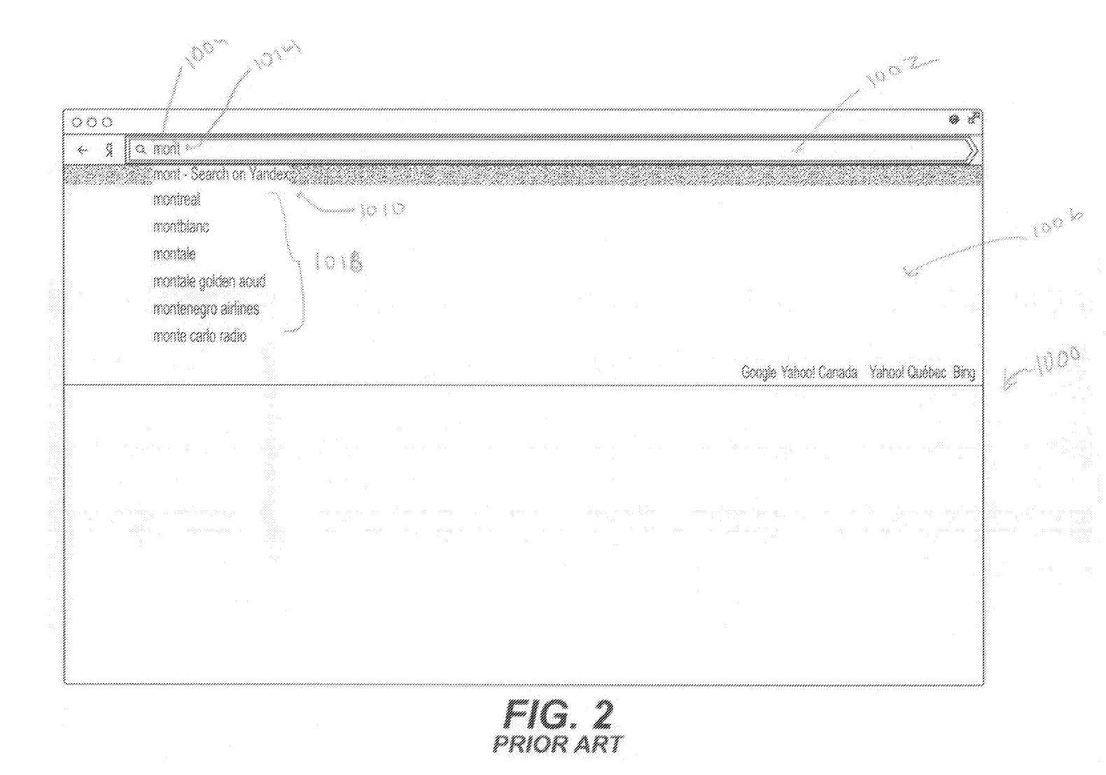

FIG. 2 shows the same browser window 1000 after the user has entered the keystroke “T” 1014 such that the letters “MONT” 1004, 1014 now appear in the omnibar 1002 of the browser 1000. The search engine query suggestion system has returned updated suggested search queries 1018 (now based on the search term “MONT”), which are now being displayed in the drop-down box 1006 (in addition to providing the user with the choice 1010 of conducting a search including the search term “MONT” in the Yandex(tm) search engine). As can be seen in the figure, some of the suggested search queries 1018 have changed in comparison to FIG. 1 (shown as 1008 in FIG. 1).

While the above described search query suggestion system works well, further improvements are always possible.

### SUMMARY

It is an object of the technology disclosed in the present specification to ameliorate at least one of the inconveniences present in the prior art, be it disclosed herein or otherwise.

It is a further object of the technology disclosed in the present specification to provide an improved method of and system for furnishing a user of a client device with a network resource.

The present technology arises from a recognition that when a user is entering a query into a search engine system, they are not always seeking information (e.g. available network resources) about the query they are entering. In some cases, by contrast, the user knows exactly the network resource that they are seeking; they are simply looking for directions as to how to get there. In the present context, this should be understood as the user having a “navigational query” as opposed to a search query. A simple example may help to illustrate the difference.

Assume that a user is looking for the website of Banff & Lake Louise Tourism. In this instance although the user knows exactly what they are looking for they do not know where to look for it. I.e., the user may not know exactly where (i.e. at what URL) the website is located. They user may thus enter into a search engine “Banff” or “Lake Louise”. As were the user to do this, there is no indication to the search engine that the user does not what anything other than a “standard” search in respect of what the system believed to be an entered search query. Therefore, a “standard” search will be conducted and a “standard” search engine results page (SERP) will be presented to the user. The SERP may provide the user with the address of, and a link to the website, that they are that they are looking for.

In the present context what the user would have actually entered in to the search engine was a navigational query. The user's entry would have been search query had the user not had known what particular internet resource for which they were looking (i.e. in this case a particular website) and were simply desirous of obtaining information about various internet resources available respecting “Banff” or “Lake Louise”.

Conducting a full “standard” search when all the user has really entered into the search engine is a navigational query is a waste search engine of resources. The present technology attempts to (although it may not always succeed) reduce such waste by (in some cases) presuming that what the user is entering is a navigational query and not a search query. Thus, in search engines employing the present technology, a search engine suggestion system will provide the user with potential internet resources that they could be seeking. (Those search engine systems ordinarily providing users with suggested search queries also employing the present technology, may provide such potential internet resources, in addition to, or in place of, suggested search queries presented to the user.). Hence (in some implementations and depending on the user entry) were the user to hit enter after having entered information into a search bar of a search engine, they would be taken directly to an internet resource that they could potentially be seeking, bypassing a search and the SERP altogether.

Thus in one aspect, some implementations of the present technology provide a method of furnishing a user of a client device having a user interface including a display, with a network resource, the method comprising:
displaying on the display of the client device a search bar;
receiving from the user of the client device via the search bar at least one portion of at least one search term;
prior to the user requesting a search in respect of the at least one portion of the at least one search term,
   sending the at least one portion of the at least one search term by the client device to at least one server;
   receiving identification of at least one network resource associated with the at least one portion of the at least one search term by the client device from the at least one server;
   sending a request to furnish a one of the at least one network resource associated with the at least one portion of the at least one search term by the client device to the at least one server; and
   receiving the one of the at least one network resource associated with the at least one portion of the at least one search term by the client device from the at least one server.

In another aspect, some implementations of the present technology provide a system for furnishing a user of a client device with a network resource, the system comprising the client device, the client device including:
a computer processor;
a user interface operationally connected with the computer processor, the user interface including a display;
a communications interface operationally connected with the computer processor and structured to communicate with at least one server;
a non-transient computer information storage medium operationally connected with the computer processor, the information storage medium storing instructions that when executed by the computer processor effect:
   displaying a search bar on the display of the client device;
   receiving at least one portion of at least one search term from the user of the client device via the search bar;
   prior to the user requesting a search in respect of the at least one portion of the at least one search term,
      sending the at least one portion of the at least one search term, by the client device to at least one server;
      receiving identification of at least one network resource associated with the at least one portion of the at least one search term by the client device from the at least one server;
      sending a request to furnish a one of the at least one network resource associated with the at least one portion of the at least one search term by the client device to the at least one server; and
      receiving the one of the at least one network resource associated with the at least one portion of the at least one search term by the client device from the at least one server.

In another aspect, some implementations of the present technology provide a non-transient computer information storage medium storing instructions that when executed by a computer processor of a client device having a user interface including a display effect:
displaying a search bar on a display of the client device;
receiving from the user of the client device via the search bar at least one portion of at least one search term;
prior to the user requesting a search in respect of the at least one portion of the at least one search term,
   sending the at least one portion of the at least one search term by the client device to at least one server;
   receiving identification of at least one network resource associated with the at least one portion of the at least one search term by the client device from the at least one server;
   sending a request to furnish a one of the at least one network resource associated with the at least one portion of the at least one search term by the client device to the at least one server; and
   receiving the one of the at least one network resource associated with the at least one portion of the at least one search term by the client device from the at least one server.

In some implementations of the above-noted aspects, the method further comprises or the instructions further effect (as the case may be), after receiving identification of at least one network resource associated with the at least one portion of the at least one search term by the client device from the at least one server and prior to sending a request to furnish a one of the at least one network resource associated with the at least one portion of the at least one search term by the client device to the at least one server, displaying the identification of the at least one network resource associated with the at least one portion of the at least one search term in a drop-down box associated with the search bar on the display of the client device.

In some implementations of the above-noted aspects, the method further comprises or the instructions further effect (as the case may be), along with displaying the identification of the at least one network resource associated with the at least one portion of the at least one search term in a drop-down box associated with the search bar on the display of the client device, displaying at least one suggested search query in respect of the at least one portion of the at least one search term in the drop-down box on the display of the client device.

In some implementations of the above-noted aspects, the method further comprises or the instructions further effect (as the case may be), after receiving identification of at least one network resource associated with the at least one portion of the at least one search term by the client device from the at least one server and prior to sending a request to furnish a one of the at least one network resource associated with the at least one portion of the at least one search term by the client device to the at least one server,
sending an additional portion of the at least one search term by the client device to the at least one server; and
receiving identification of at least one network resource associated with both the additional portion of and the at least one portion of the at least one search term by the client device from the at least one server; and
   wherein:
sending a request to furnish a one of the at least one network resource associated with the at least one portion of the at least one search term by the client device to the at least one server, is, sending a request to furnish a one of the at least one network resource associated with both the additional portion of and the at least one portion of the at least one search term by the client device to the at least one server; and
receiving the one of the at least one network resource associated with the at least one portion of the at least one search term by the client device from the at least one server, is, receiving the one of the at least one network resource associated with both the additional portion of and the at least one portion of the at least one search term by the client device from the at least one server.

In another aspect, some implementations of the present technology provide a method of furnishing a user of a client device having a user interface including a display displaying a search bar, with a network resource, the method comprising:
receiving at least a portion of at least one search term having been entered in the search bar, by at least one server from the client device;
sending identification of at least one network resource associated with the at least one portion of the at least one search term by the at least one server to the client device;
receiving a request to furnish a one of the at least one network resource associated with at least one portion of the at least one search term by the least one server from the client device; and
sending the one of the at least one network resource associated with the at least one portion of the at least one search term by the at least one the server to the client device;
   all prior to the at least one server having received a request for a search in respect of the at least one portion of the at least one search term.

In another aspect, some implementations of the present technology provide a system for furnishing a user of a client device having a user interface including a display displaying a search bar, with a network resource, the system comprising at least one server, the at least one server including:
a computer processor;
a communications interface operationally connected with the computer processor and structured to communicate with the client device;
a non-transient computer information storage medium operationally connected with the computer processor, the information storage medium storing instructions that when executed by the computer processor effect:
receiving at least a portion of at least one search term having been entered in the search bar by the at least one server from the client device;
sending identification of at least one network resource associated with the at least one portion of the at least one search term by the at least one server to the client device;
receiving a request to furnish a one of the at least one network resource associated with at least one portion of the at least one search term by the at least one server from the client device; and
sending the one of the at least one network resource associated with the at least one portion of the at least one search term by the at least one the server to the client device;
   all prior to the at least one server having received a request for a search in respect of the at least one portion of the at least one search term.

In another aspect, some implementations of the present technology provide a non-transient computer information storage medium storing instructions that when executed by a computer processor of at least one server effect:
receiving at least a portion of at least one search term having been entered in a search bar displayed on a display of a user interface of a client device by the at least one server from a client device;
sending identification of at least one network resource associated with the at least one portion of the at least one search term by the at least one server to the client device;
receiving a request to furnish a one of the at least one network resource associated with at least one portion of the at least one search term by the at least one server from the client device; and
sending the one of the at least one network resource associated with the at least one portion of the at least one search term by the at least one the server to the client device;
   all prior to the at least one server having received a request for a search in respect of the at least one portion of the at least one search term.

In some implementations of the above-noted aspects, the method further comprises or the instructions further effect (as the case may be), after receiving at least a portion of at least one search term having been entered in the search bar of the browser by the at least one server from the client device and prior to sending identification of at least one network resource associated with the at least one portion of the at least one search term by the at least one server to the client device, retrieving the indication of the at least one network resource associated with the at least one portion of the at least one search term from a database operationally connected with the at least one server.

In some implementations of the above-noted aspects, the at least one network resource associated with the at least one portion of the least one search term has been determined based on an analysis of previous network resources having been selected by users having requested searches including the at least one portion of the at least one search term.

In some implementations of the above-noted aspects, the method further comprises or the instructions further effect (as the case may be), after sending identification of at least one network resource associated with the at least one portion of the at least one search term by the at least one server to the client device and prior receiving a request to furnish a one of the at least one network resource associated with at least one portion of the at least one search term by the least one server from the client device,
receiving an additional portion of the at least one search term by the at least one server from the client device; and
sending identification of at least one network resource associated with both the additional portion of and the at least one portion of the at least one search term by the at least one server to the client device; and
   wherein:
receiving a request to furnish a one of the at least one network resource associated with the least one portion of the at least one search term, by the least one server from the client device, is, receiving a request to furnish a one of the at least one network resource associated with both the additional portion of and the least one portion of the at least one search term by the least one server from the client device; and
sending the one of the at least one network resource associated with the at least one portion of the at least one search term by the at least one the server to the client device, is, sending the one of the at least one network resource associated with both the additional portion of and the at least one portion of the at least one search term by the at least one the server to the client device.

In some implementations of the any of the above-noted aspects, the identification of the at least one network resource associated with the at least one portion of the at least one search term includes a uniform resource locator (URL) of the at least one network resource.

In some such implementations, the URL of the at least one network resource does not include the at least one portion of the at least one search term.

In some implementations of any of the above-noted aspects, the identification of the at least one network resource associated with the at least one portion of the at least one search term includes a title of the at least one network resource. In some such implementations, the title of the at least network resource does not include the at least one portion of the at least one search term.

In some implementations of any of the above-note aspects, the search bar may be a dedicated search bar (e.g. used exclusively for entering search queries.) In some other implementations of any of the above-noted aspects, the search bar is a multi-function bar (e.g.

it is one of the functions of a multi-function bar (e.g. used for navigation and search query entry, an “omnibar”).

In some implementations of any of the above-noted aspects, wherein the search bar is part of a browser (e.g. an Internet web browser). The search bar not need, however, be part of a browser. In some implementations of any of the above-noted aspects, it is, for example, part of a dedicated searching app (e.g. a dedicated search app used on a mobile device.)

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “at least one server” is intended to mean that every task (e.g. received instructions or requests) or any particular task will not necessarily have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “user interface” includes the physical components (e.g. hardware) that allow a human user to interact with an electronic device. Thus, some (non-limiting) examples of elements of a user interface include a screen (which may be used for output or for input/output), a keyboard, a mouse, a track pad, a speaker, earphone, a microphone, etc.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

For a better understanding of the present invention, as well as other aspects and further features thereof, reference is made to the following description which is to be used in conjunction with the accompanying drawings, where:

FIG. 1 is view of a browser window showing an operation of a prior art search engine query suggestion system.

FIG. 2 is a view of a browser window showing an operation of a prior art search engine query suggestion system.

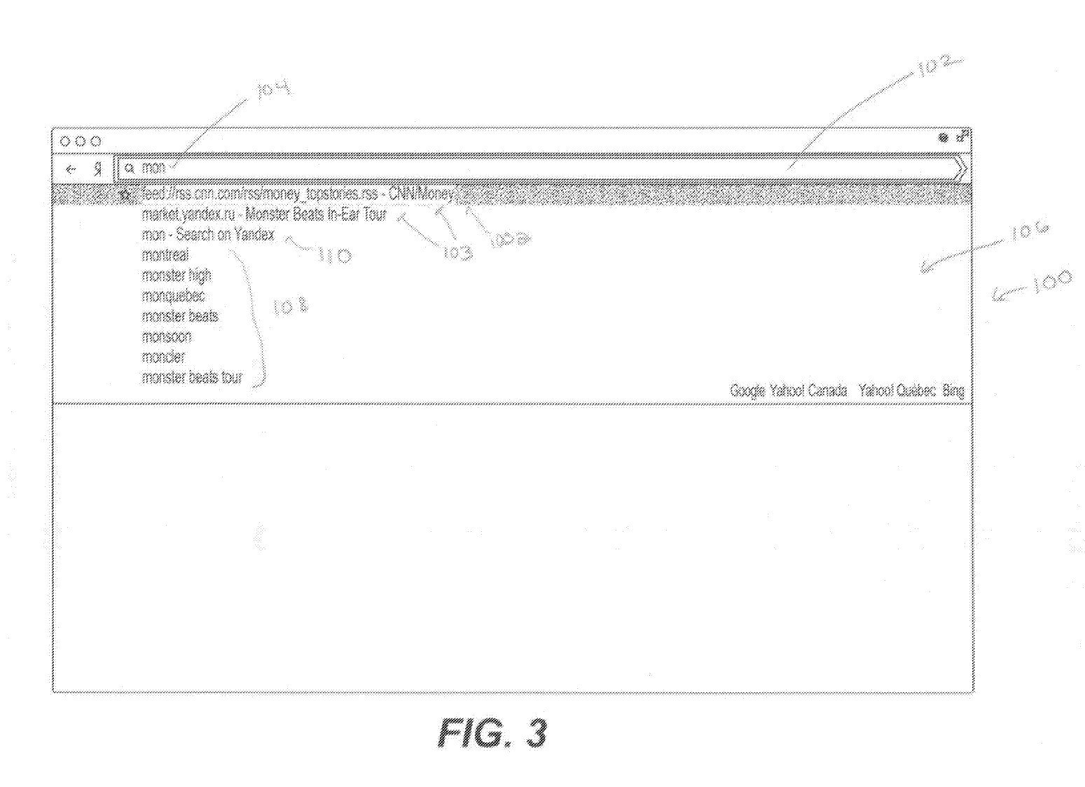

FIG. 3 is a view of browser window showing an operation of an implementation of the present technology.

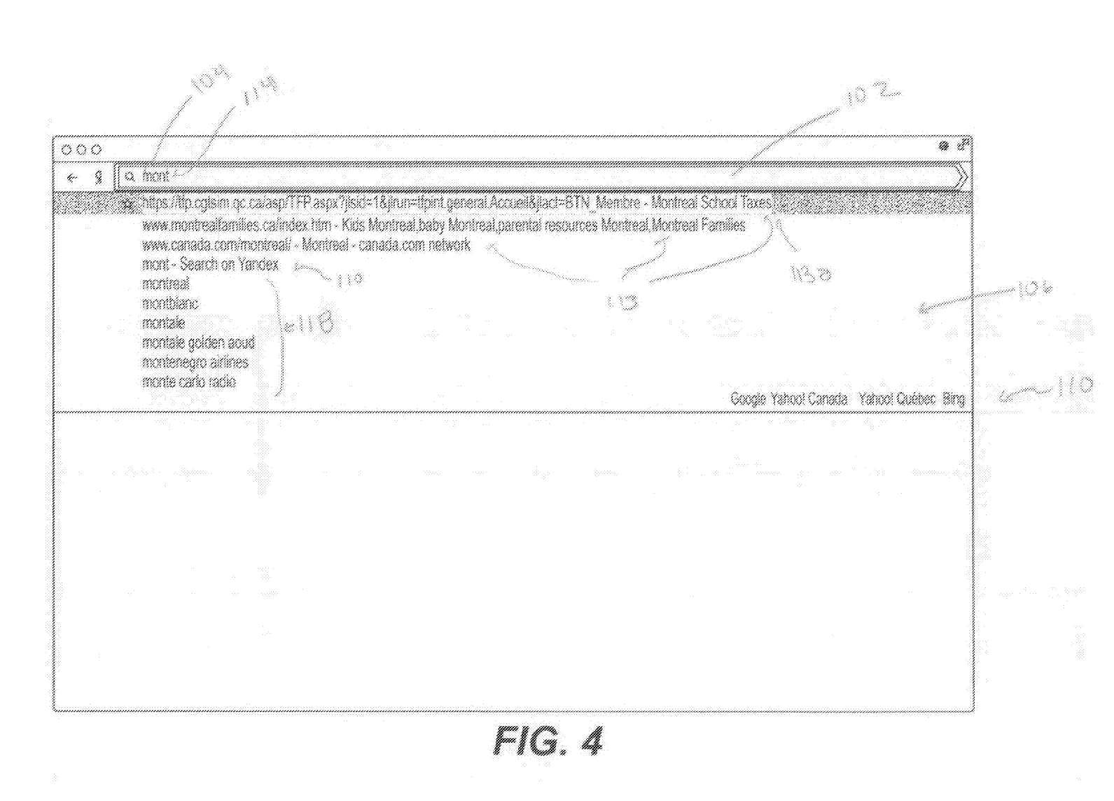

FIG. 4 is a view of a browser window showing an operation of an implementation of the present technology.

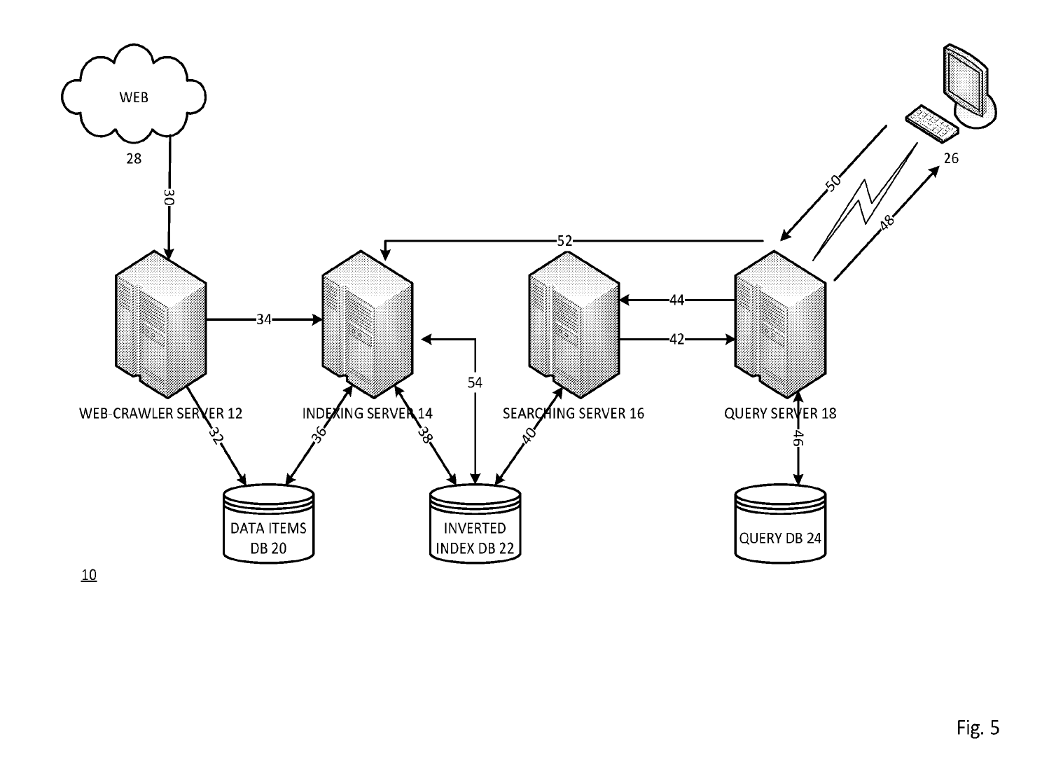

FIG. 5 is a schematic view of computer systems that may be used to implement the present technology.

### DETAILED DESCRIPTION

In order to provide a better understanding of the present technology, referring to FIG. 5, the following description is provided:

A Internet search engine 10, includes four different types of servers (or groups of servers), shown in FIG. 5 as “web-crawler” server 12, “indexing” server 14, “searching” server 16, and “query” server 18, which are each individually described below.

Web-crawler server 12 implements an Internet “web crawler”, whose function it is to seek out and collect copies of webpages from the World-Wide Web (shown as “Web” 28 in FIG. 5) and store each of those pages as “data items” in the “data items” database 20. For each data item, web-crawling server 12 calculates and stores in the data items database 20 a “query-independent relevance” (“QIR”) value.

Indexing server 14 is an indexing server that (re)numbers the data items in the data items database 20. Indexing server 14 also creates and maintains an inverted index in the data items in the “inverted index” database 22.

Searching server 16 is a searching server that receives search queries from query server 18 (see below), performs searches across the inverted index stored in the inverted index database 22 in respect of such search queries, and builds a QIR-ordered search result list.

Query server 18 implements the functions of a query server that receives and parses search queries from users (represented by personal computer 26); and for some search queries (or portions thereof) received, query server 18 provides search query suggestions and initiates a search operation by the searching server 16 (further discussion is provided below).

For example, in respect of a requested search, Query server 18 obtains the QIR-ordered “search result list” from searching server 16 in respect of the search. Query server 18 calculates for at least some of the data items in the search result list a “query-specific relevance” (“QSR”), and query server 18 builds a QSR-ranked search result list in respect of the search. Query server 18 extracts a “title” and a query-specific “snippet” from the data items database 20 for each data item in the search result list. Query server 18 delivers to the search requester 26 portions of the QSR-ranked search list, together with their titles and snippets. As is also known in the art, query server 18 further records the search requester's actions of “clicking through” on some of the data items shown to them as part of the search results, and stores appropriate data regarding such click-throughs in its “query database” 24. Query server 18 also searches information regarding past queries in the query database 24 when preparing the search results for a current query and defines the QSR-ranking of at least some search results as a function of the information found in the query database 24 before delivering the search results to the search requester.

Having described the general overall functions of each of the servers 12, 14, 16, and 18 some of the specific operations of the servers 12, 14, 16 and 18 will now be described. In this respect, web-crawling server 12 implements a web crawler that (permanently or periodically—as the case may be) explores the World Wide Web finding new (or recently updated) web pages (illustrated by data path 30). For each such web page that is found a data item is created in the data items database 20 (illustrated by data path 32). In a typical conventional Internet search engine, each data item in the data items database 20 is/has a local copy of the corresponding web page on the Internet, a hyperlink to the original web page on the Internet (also called its web address), and a set of data-item attributes that were assigned to the data item during the course of its processing by the search engine system 10. Some of these data-item attributes may be described herein, however others not mentioned herein may also be defined and used by various conventional search engines.

With respect to any new data item, the first operation carried out is to define that data item's QIR value. As QIR values are used for data items ordering, they are typically implemented as a numerical (although not necessarily an integerial) characteristic of a data item. A QIR value is calculated by the search engine system 10 using many different attributes of the data item itself (including, but not limited to, its title, creation date, original web page location, etc.), and using the number and qualities of references to that data item on other Web pages, and likely also using some “historical” data having been “learned” by the system 10 from data items having been previously entered into the system, from previously executed search queries, and other conventionally-used information. In this respect, there exist a few methods that are well-known in the art for defining a QIR value in a practical suitable manner. In most conventional Internet systems, the calculation of a QIR value for each new data item is performed by the web-crawler server 12; however in some others it is performed by a different server, such as, for example, indexing server 14 or a dedicated QIR server.

Each data item stored in the data items database 20 is known within the system 10 by its unique system-assigned identifier, which is a typically an ordinal number. Typically the entire collection of data items managed by a large Internet search engine is too large to be contained on one database server, and thus it is customarily is split into several database “shards”. Where such is the case, each shard will typically have its own data item numbering scheme and its own logic for performing a search on its portion of the document database. When executing a search query each of the partial per-shard search result lists, once generated, are merged into one common QIR-ordered list, which is then QSR ordered.

Data items are numbered by the system 10 in descending order of their QIR, rather than in the order that they have been obtained by the web-crawler server 12. Data items having the same QIR can be numbered in any order, for example in inverse chronological order (the latest data items being assigned lesser numbers, in order to be found before the earlier ones). Hence, if a newly received data item D appears to have its QIR value less than that of an existing data item (say #999), but greater than or equal to the QIR value of the next data item (#1000), then D will be assigned #1000, while the old #1000 will become #1001 and so on. Hence, both the data item numbers and the content of the inverted index (see below) are permanently or periodically updated. Typically the data item (re)numbering operation is performed by the indexing server 120, but this is not required to be the case.

Once a data item (e.g. D) is received by the web crawler server 12, stored in the data items database 20, assigned its QIR value, assigned its data item number (e.g. #1000), it is passed on to the indexing server 14 (data path 34 on FIG. 1) for further processing by the latter (bidirectional data path 36). The indexing server 14 manages its database 22 (bidirectional data path 38), which basically comprises an inverted index of the data item collection contained in the data items database 20. As was described hereinabove, the inverted index basically comprises a number of posting lists. The indexing server 14 inspects the new data item #1000, discerns in it various “searchable terms”, and for each searchable term found it finds in the data item it creates a new entry (e.g. a “posting”) in the appropriate posting list.

A posting in a posting list basically includes a data item number (or other information sufficient to calculate a data item number), and may optionally includes some additional data. Every posting list corresponds to a searchable term, and comprises a series of postings referencing each of those data items in the data items database 20 that contain at least one occurrence of that searchable term.

Additional data may also be found in a posting; for example, the number of occurrences of a given searchable term in a given data item; whether this search term occurs in the title of the data item, etc. This additional information may be different depending on the search engine.

Searchable terms are typically, but not exclusively, words or other character strings. A general use Web search engine typically deals with practically every word in a number of different languages, as well as proper names, numbers, symbols, etc. Also included may be “words” having commonly found typographical errors. In the present specification, any such searchable term may be referred to as a “word” or a “term”. For each searchable term that has been encountered in at least one data item, the indexing server 14 updates the corresponding posting list, or creates a new one if the term is being encountered for the first time. Hence the total number of posting lists may be as large as a few million. The length of a given posting list depends on how commonly used the corresponding word is in the data items universe (e.g. on the Internet). A very commonly used word may have a posting list of as long as one billion entries (or even more—there is no limit). (In practical use, when the data items database 20 is split into several “shards”, each shard maintains its own separate inverted index 22, thus greatly reducing the length of posting lists in each shard.)

In each posting list, data item postings are placed in an ascending order of their data item numbers, that is, in the descending order of their QIR. Hence, the process of indexing a new data item D is not limited to inserting the data item number of D, say #1000, into the posting list of every word Tᵢ occurring in D. Rather, when assigning to D an already existing data item number #1000, every existing posting in every posting list, to data item number equal or greater than #1000, must be updated (incremented by 1 in this example). In actuality, conventional search engines typical perform this update operation periodically for batches of data items having been received since the previous time that the inverted index database 22 was updated.

Data items stored in the data items database 20 and indexed in the inverted index database 22 can then be searched for. Again with reference to FIG. 5, search queries are made by human users (“search requesters” which are collectively depicted on FIG. 5 by an image of a personal computer 26) and are received by the query server 18 (data path 50 in FIG. 5). The query server 18 parses each search query received into its various search terms (which may include optionally dropping auxiliary words such as prepositions and conjunctions not to be searched for because of their ubiquity), and may also perform some other convention actions. For example, a search query Q₁, received at time tₒ, may comprise four search terms T₁, T₂, T₃, T₄. This is denoted as Q₁[T₁,T₂,T₃,T₄].

The query Q₁ is then passed by the query server 18 to the searching server 16 (data path 44). The latter basically operates on the inverted index database 22, that is, on the inverted index with its many posting lists. In this example, the search process, or execution of a search query, consists of finding the data item numbers of all those data items that contain occurrences of each search term specified in the search query (as was discussed above this is the simplest form of a search process; in a further example described below a quorum principle will be introduced). Typically this is done by exploring in parallel each of the posting lists corresponding to the search terms of the query, starting from the beginning of each posting list. In the present example, posting lists P₁, P₂, P₃, P₄ corresponding to the search terms T₁, T₂, T₃, T₄ respectively. (in a more general manner the posting list corresponding to a term Tₙ, is denoted in this specification as Pₐ). A data item whose number is encountered in each posting list relevant to the search query is considered to be a search result (sometimes also conventionally called a “hit”), and is placed in a search result list as the search result list's then next element (i.e. after hits already having been placed in the result list). In this way, the search result list of a search query is in ascending order of data item numbers, and thus in descending order of QIR value.

This procedure of finding further search results stops either when reaching the end of one of the posting lists, or when some “pruning condition” (as was mentioned above) has been satisfied. In various conventional examples, the pruning condition might, for example, be defined by the query server 18 on a per query basis and provided with each query Q by the query server 18 to the searching server 16; alternatively the pruning condition might be fixed with respect to system and be the same for all queries. In either case, the pruning condition could be expressed, for example, as a maximum number of data items in the search result list, or as a minimum QIR value for a data item to be included in the search result list, or in another different conventional matter. In any case, application of a pruning condition is supposed to “pick” the best results in terms of their QIR.

The search result list prepared by the search server 16 for a given query, e.g. for Q₁, is then sent back by searching server 16 to the query server 18 (data path 42). (In the following description the search result list for a query Qₘ is denoted as “R(Qₘ)”. In terms of two-stage query execution described above, the first stage—collection of search results—is now terminated, and the second stage, that of ranking, or reordering, of the search result list starts. In this respect, the query server 18, before delivering the results to the search requester, reorders them in a way presumably most suitable for this particular given query, by placing at the highest positions in the list those search results (data items) that have the highest query-specific relevance (QSR) for that particular given query. This QSR-ranking and reordering of the originally QIR-ordered search result list is probably the most sophisticated operation performed by a Web search engine, and the one most influencing final user (e.g. search requester) satisfaction.

In order to define in a best QSR ranking for a particular given query, information from many different sources is taken into account at the same time. Part of the information used assessing the QSR of a data item may be found in the data item itself; for example, the total number of occurrences in the data item of each search term of the given search query; occurrences of two or more of the search terms found in close proximity to each other (e.g. in the same phrase), or, yet better, following each other in the same order as in the search query; search terms found in the title of the document, etc. However, all these are limited-scope criteria that might not necessary reflect the level of “user satisfaction” with a given data item in the context of a given particular query.

Hence, some conventional Web search engines make use of historical information collected from a large quantity of previously executed search queries, and stored in a database. This “query database” is shown on FIG. 5 in association with reference number 24, and accessed by the query server 18 via bidirectional data-path 46. As is known in the art, from each query, diverse information can be extracted, stored and processed, and then used for better QSR-ranking of results for the next query. In the context of the present example, only “click-through” data as was briefly discussed above is relevant. In this respect, a user, U₁ having made a search query, say, Q₁[T₁,T₂,T₃,T₄], receives from the query server 18 a list of search results having been found for the query by the searching server 16 and further having been ranked by the query server 18 (as was previously discussed above). In many cases the list is very long, so it is sent to the user in portions (or “pages”) of, for example, 20 entries each. Every entry is “clickable”, that is, if clicked by the user with their mouse or other pointing device, causes the data item to open, for example, in another window or another tab of the browser application on the user's computer. It is likely beneficial for the user to be provided with a quick glance at each of the search results prior to opening them, so that they do not waste their timing having to open data item after data item trying to locate the right one. To that end, the query server 18 typically provides the user with a “snippet”, a short citation (or a few yet shorter fragments collected together) from the data item where the requested search terms occur in a presumably self-explanatory context. After looking the snippet (as well as the other information provided) the user can decide whether to open the data item (by “clicking through”) to it or not.

Upon opening a data item, the user can look at it more carefully and decide whether it is definitely of interest to them or not. While the search engine has no way of explicitly “knowing” whether or not the data item is of interest to the user, the search engine can record the mere fact of the user having clicked-through to a given data item appearing on the search result page. This is because the search result page is typically provided to the user by the search engine in a Web application that is typically programmed in a way that every “click-through” action on the page is first sent back to the search engine (in the present example to query server 18 of the system 10). The query server 18 then redirects the user to the web-page of the requested data item (or, alternatively, shows them a copy of the data item stored in the data items database 20). In this way, the query server 18 is capable of recording all the click-through actions performed by users on search result pages provided to them.

It has been statistically verified that, among search results of a query that have been effectively shown to the query issuer, those that have been clicked-through by them were on average of more interest to them than those not clicked-through. Moreover, the last clicked-through data item in the list, that is, the one after which the user stopped further inspection of the list and did not click through to any other items, has proven to be on average of yet more interest to the user than all the previously clicked-through documents. These statistical considerations and “click-through history” are used for better ranking a search result list for every next search query, by using the “click-through history” from past search queries.

The query database 18 stores click-through data from past queries in the form of records <Dₖ; Qₘ[T₁,T₂,T₃, . . . Tₙ]> indicating that the document Dₖ had been clicked through by the issuer of the query Qₘ[T₁, T₂, T₃, . . . Tₐ] when he/she was exploring the search results for that query. Optionally, as is known in the art, there could also be recorded (and then used at same later time) data with respect to the search requester (e.g. their IP address), the query execution time; etc. The above collection of records represents a database that can be sorted by documents clicked through, or by some or all the search terms used in queries, or in any other way.

For example, the user U₁ issues a query Q₁[T₁,T₂,T₃,T₄], which is executed by the searching server 16 by examining the posting lists P₁, P₂, P₃, P₄ of the search terms T₁, T₂, T₃, T4 (respectively) of the search query Q₁. Illustratively, a data item D₁ (more exactly, a posting (i.e. a reference) to D₁) is found in each of these posting lists; hence D₁ is included in the search result list R(Q₁) for the query Q₁. The search result list is, after some QSR reordering, presented to the user U₁. The user U₁ clicks through the entry corresponding to the data item D₁ in the list, considering that it might be of interest to them. (The fact of a data item having been clicked through is schematically indicated on both FIG. 2 and FIG. 3 by an asterisk “*”.) This information is stored in the query database 24 as a record <D₁; Q₁[T₁, T₂, T₃, T₄]>.

At some later point in time, by comparing queries with “almost the same” search terms, and/or with “mostly the same” search result lists, especially those with “mostly the same” subsets of their “clicked-through” results, the system 10 (namely, its query server 18) can establish some “degree of similarity” among past queries, and also between a next query, e.g. Q₂, and some of the past queries, e.g. Q₀. As how this occurs is both complicated and conventional the details thereof will not be discussed herein; what is important for present purposes is to understand how information from past queries similar to a current query Q₂ is conventionally used to help a search engine to deliver more appropriate results to the current search requester.

In this respect, if a then current query, e.g. Q₂, is found to be similar to some past query, e.g. Q₁, and if among the search results for Q₂ there is a data item D₁, for which a record <D₁; Q₁[ . . . ]> exists in the query database 24, signifying that the document D₁ was among the results for Q₁ as well, and, moreover, had been clicked through by the past issuer of Q₁, then the data item D₁ is considered as being of higher QSR for Q₂ than other results for Q₂ with same or similar other characteristics. In other words, the above criterion of “having been clicked through in one or more past similar queries”, while not decisive, is used as one of the criteria capable of increasing the QSR of D₁ for Q₂, and hence of pushing D₁ higher in the ordered list of search results for Q₂. Thus D₁ will be shown to the search requester in the search result list at an earlier time than had D₁ not previously been clicked through.

A user U₂ (which may be the same as U₁ or may be another user) issues a search query Q₂[T₁,T₂,T₄,T₅] that differs from the previously considered query Q₁[T₁,T₂,T₃,T₄] in that it does not include the search term T₃, but rather includes some other search term T₅ instead. Again, the searching server 16 looks through the posting lists corresponding to the search terms, this time the posting lists P₁, P₂, P₄, P₅ corresponding to search terms T₁, T₂, T₄, T₅ of the query Q₂. (In FIG. 2 this is shown in a second image of the indexing database 22, denoted 22(2).) Illustratively, the same document D₁ is again found in each of the posting lists; hence D₁ is included in the search result list R(Q₂) for query Q₂. However, this time the result list R(Q₂) contains too many other documents of presumably higher relevance to the user U₂, for the document D₁ to be even shown to them. This is illustratively depicted on FIG. 2 by placing D₁ in a lower position within the list R(Q₂).

In according to conventional use of click-through data, however, the query server 18, before presenting the result list R(Q₂) to the user U₂, looks up in the query database 24, and finds there (amongst probably other information) the previously stored record <D₁;Q₁[T₁,T₂,T₃,T₄]> showing that the document D₁ had been clicked through in one of the previous queries, namely in the query Q₁[T₁,T₂,T₃,T₄] that differs from the then present query Q₂[T₁,T₂,T₄,T₅] by just one of their four search terms. Considering that the fact that it had been clicked through brings some additional value to D₁, the query server 18 now upgrades the document D₁ to a higher position in the list R(Q₂), such that D₁ will now be presented to user U₂.

In some implementations, for example, personal computer 26 is a conventional notebook computer running the Microsoft™ Windows™ operating system and having the Yandex.Browser™ web browser program loaded and running thereon. (In other implementations, portable computer could be other types of hardware (e.g. notebook computers, laptop computers, tablet computers, netbook computers, etc.) and/or could be running other operating systems (e.g. Linux™, Mac OS X™, etc.) and/or other programs.) Personal computer 26 is connected to the Internet in a conventional manner over a wireless communications link. (In other implementations, personal computer 26 could be connected to the Internet over a conventional wired link (e.g. Ethernet).) Personal computer 26 when running Yandex.Browser acts as a client device in respect of the present technology (described below).

In some implementations, for example, personal computer 26 is a conventional desktop computer running the Apple™ Macintosh™ operating system, and having the Yandex.Browser web browser program loaded and running thereon. Desktop computer 26 is connected to the Internet 110 in a conventional manner over a wired communications link. Personal computer 26 when running Yandex.Browser acts as a client device in respect of the present technology (described below). As was the case with the portable computer described above, in other implementations, the hardware and/or software aspects of desktop computer may vary in a similar fashion.

In still other implementations, for example, personal computer 26 is a smartphone a conventional Samsung™ Galaxy™ SIII smartphone running the Google Android™ operating system, and having the Yandex™ search™ application loaded and running thereon. Smartphone 26 is connected to the Internet in a conventional manner over a mobile network. In other implementations, smartphone 26 could be connected to the Internet in another manner such as wirelessly via Bluetooth™ or WiFi™. The Yandex search app enables the smartphone 124 when to act as a client device in respect of the present technology (described below). As was the case with portable computer and desktop computer described above, in other implementations the hardware and/or software aspects of smartphone 26 will vary. No particular smartphone hardware or software is required in respect of the present technology.

In some implementations, the present technology, as well as search query suggestion system as is implemented by query server 18 (in communication with query database 24), in conjunction with personal computer 26. In addition to the query server 18 being provided with data after a search has been conducted (as was described above), the query server is provided with data prior to a search being conducted. Such data may include (portions of) search queries entered by a user, navigation suggestions and/or search query suggestions provided by the query server 18 to the user and an indication of what the user then clicked-up or entered following their having been presented with such suggestions.

In this respect FIG. 3 shows a Yandex browser window 100 implementing the present technology. In FIG. 3, similar to FIG. 1, the user has entered the letters “MON” 104 in the omnibar 102 (which is includes the functions of a search bar in this implementation). As the user types in the letters 104 into the omnibar, the Yandex browser sends those letters to the search query server 18 via the Internet (represented by data path 48). The query server 18 retrieves from the query database 24 appropriate “click-through data” respecting instances where users had entered in the same data in the search bar, and were provided with navigational suggestions and/or search query suggestions that were ultimately “clicked through” (i.e. selected by the user). The query server 18 sends such navigation suggestions and search query suggestions back the personal computer 26 over the Internet (represented by data path 50). The Yandex browser is configured to receive such suggestions and display them to the user. Thus, in addition to the suggested search queries 108 and the choice 110 to conduct a search via the Yandex search engine that were shown in FIG. 1, appearing in the drop down box 106 (at the top of the list) are the addresses (URLs) of two particular internet resources 103 that the user may be seeking to be navigated to. In this case, as the default highlighted entry is the first entry on the list 103a, were the user to press the enter key, they would be navigated directly to the top resource 103a in the list without conducting (or ever having conducted) a standard search in respect of their entry. This occurs as in such a case the Yandex browser is configured to retrieve the Internet resource located at the URL of the navigation suggestion, and not to conduct an internet search on such suggestion. The Yandex browser is also configured to sent such “click-through” data back to the query server 18 so that the query server 18 can update the query database 24 with that information and use it again in the future the next time a user enters such a (partial) search query,

FIG. 4 shows the same browser window 100 after the user has entered the keystroke “T” 114 such that the letters “MONT” 104, 114 now appear in the omnibar 102 of the browser 100. (The user did not want to be navigated to one of the resources 103 nor conduct a search in respect of one of the suggested search queries 108.) Now the letters “MONT” are sent to the query server 18, which in turn retrieves the relevant data from the query database 24, and sends it to the personal computer 26. Again, in addition to the suggested search queries 108 and the choice 110 to conduct a search via the Yandex search engine that were that were shown in FIG. 2, appearing in the drop down box 102 (at the top of the list) are the addresses (URLs) of three particular internet resources 113 that the user may be seeking to be navigated to (all of which have been received from the query server 18). However, because the additional letter T 114 having been entered into the omnibar 102, the addresses (URLs) of three particular internet resources 113 that the user may be seeking to be navigated to are different than those 113 shown in FIG. 3. Again, as the default highlighted entry 113a is the first entry on the list 113, were the user to press the enter key, they would be navigated directly to the top resource 113a in the list without conducting (or every having conducted) a standard search in respect of their entry.

In this implementation, in both FIGS. 3 and 4 the internet resources 103, 113 displayed to the user and available for selection have been retrieved from a database that stores the most selected internet addresses that users having conducted searches in the past using the letters having been entered into the search bar 102 as a search term have selected.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of furnishing a user of a client device having a user interface including a display, with a network resource, the method comprising:
displaying on the display of the client device a search bar;
receiving from the user of the client device via the search bar at least one portion of at least one search term;
prior to the user requesting a search in respect of the at least one portion of the at least one search term,
sending the at least one portion of the at least one search term by the client device to at least one server;
receiving identification of at least one network resource associated with the at least one portion of the at least one search term by the client device from the at least one server;
sending a request to furnish a one of the at least one network resource associated with the at least one portion of the at least one search term by the client device to the at least one server; and
receiving the one of the at least one network resource associated with the at least one portion of the at least one search term by the client device from the at least one server.

2. The method of claim 1, wherein the identification of the at least one network resource associated with the at least one portion of the at least one search term includes a uniform resource locator (URL) of the at least one network resource.

3. The method of claim 2, wherein the URL of the at least one network resource does not include the at least one portion of the at least one search term.

4. The method of any one of claims 1 to 3, wherein the identification of the at least one network resource associated with the at least one portion of the at least one search term includes a title of the at least one network resource.

5. The method of claim 4, wherein the title of the at least network resource does not include the at least one portion of the at least one search term.

6. The method of any one of claims 1 to 5, further comprising, after receiving identification of at least one network resource associated with the at least one portion of the at least one search term by the client device from the at least one server and prior to sending a request to furnish a one of the at least one network resource associated with the at least one portion of the at least one search term by the client device to the at least one server, displaying the identification of the at least one network resource associated with the at least one portion of the at least one search term in a drop-down box associated with the search bar on the display of the client device.

7. The method of claim 6, further comprising, along with displaying the identification of the at least one network resource associated with the at least one portion of the at least one search term in a drop-down box associated with the search bar on the display of the client device, displaying at least one suggested search query in respect of the at least one portion of the at least one search term in the drop-down box on the display of the client device.

8. The method of claim 7, wherein the identification of the at least one network resource associated with the at least one portion of the at least one search term is displayed first in the drop-down box on the display of the client device.

9. The method of any one of claims 1 to 8, wherein the search bar is a multi-function bar.

10. The method of any one of claims 1 to 9, wherein the search bar is part of a browser.

11. The method of any one of claims 1 to 10, further comprising, after receiving identification of at least one network resource associated with the at least one portion of the at least one search term by the client device from the at least one server and prior to sending a request to furnish a one of the at least one network resource associated with the at least one portion of the at least one search term by the client device to the at least one server,
sending an additional portion of the at least one search term by the client device to the at least one server; and
receiving identification of at least one network resource associated with both the additional portion of and the at least one portion of the at least one search term by the client device from the at least one server; and
wherein:
sending a request to furnish a one of the at least one network resource associated with the at least one portion of the at least one search term by the client device to the at least one server, is, sending a request to furnish a one of the at least one network resource associated with both the additional portion of and the at least one portion of the at least one search term by the client device to the at least one server; and
receiving the one of the at least one network resource associated with the at least one portion of the at least one search term by the client device from the at least one server, is, receiving the one of the at least one network resource associated with both the additional portion of and the at least one portion of the at least one search term by the client device from the at least one server.

12. A system for furnishing a user of a client device with a network resource, the system comprising the client device, the client device including:
a computer processor;
a user interface operationally connected with the computer processor, the user interface including a display;
a communications interface operationally connected with the computer processor and structured to communicate with at least one server;
a non-transient computer information storage medium operationally connected with the computer processor, the information storage medium storing instructions that when executed by the computer processor effect:
displaying a search bar on the display of the client device;
receiving at least one portion of at least one search term from the user of the client device via the search bar;
prior to the user requesting a search in respect of the at least one portion of the at least one search term,
sending the at least one portion of the at least one search term, by the client device to at least one server;
receiving identification of at least one network resource associated with the at least one portion of the at least one search term by the client device from the at least one server;
sending a request to furnish a one of the at least one network resource associated with the at least one portion of the at least one search term by the client device to the at least one server; and
receiving the one of the at least one network resource associated with the at least one portion of the at least one search term by the client device from the at least one server.

13. The system of claim 12, wherein the information storage medium further stores instructions that when executed by the computer processor effect, after receiving identification of at least one network resource associated with the at least one portion of the at least one search term by the client device from the at least one server and prior to sending a request to furnish a one of the at least one network resource associated with the at least one portion of the at least one search term by the client device to the at least one server, displaying the identification of the at least one network resource associated with the at least one portion of the at least one search term in a drop-down box associated with the search bar on the display of the client device.

14. The system of claim 13, wherein the information storage medium further stores instructions that when executed by the computer processor effect, along with displaying the identification of the at least one network resource associated with the at least one portion of the at least one search term in a drop-down box associated with the search bar on the display screen of the client device, displaying of least one suggested search query in respect of the at least one portion of the at least one search term in the drop-down box on the display of the client device.

15. The system of claim 14, wherein the identification of the at least one network resource associated with the at least one portion of the at least one search term is displayed first in the drop-down box on the display of the client device.

16. The system of any one of claims 12 to 15, wherein the search bar is a multi-function bar.

17. The method of any one of claims 12 to 16, wherein the search bar is part of a browser.

18. The system of any one of claims 12 to 17, wherein the information storage medium further stores instructions that when executed by the computer processor effect, after receiving identification of at least one network resource associated with the at least one portion of the at least one search term by the client device from the at least one server and prior to sending a request to furnish a one of the at least one network resource associated with the at least one portion of the at least one search term by the client device to the at least one server,
sending an additional portion of the at least one search term by the client device to the at least one server; and
receiving identification of at least one network resource associated with both the additional portion of and the at least one portion of the at least one search term by the client device from the at least one server; and
wherein:
sending a request to furnish a one of the at least one network resource associated with the at least one portion of the at least one search term by the client device to the at least one server, is, sending a request to furnish a one of the at least one network resource associated with both the additional portion of and the at least one portion of the at least one search term by the client device to the at least one server; and
receiving the one of the at least one network resource associated with the at least one portion of the at least one search term by the client device from the at least one server, is, receiving the one of the at least one network resource associated with both the additional portion and the at least one portion of the at least one search term by the client device from the at least one server.

19. A non-transient computer information storage medium storing instructions that when executed by a computer processor of a client device having a user interface including a display effect:
displaying a search bar on a display of the client device;
receiving from the user of the client device via the search bar at least one portion of at least one search term;
prior to the user requesting a search in respect of the at least one portion of the at least one search term,
sending the at least one portion of the at least one search term by the client device to at least one server;
receiving identification of at least one network resource associated with the at least one portion of the at least one search term by the client device from the at least one server;
sending a request to furnish a one of the at least one network resource associated with the at least one portion of the at least one search term by the client device to the at least one server; and
receiving the one of the at least one network resource associated with the at least one portion of the at least one search term by the client device from the at least one server.

20. The non-transient computer information storage medium claim 19, wherein the information storage medium further stores instructions that when executed by the computer processor effect, after receiving identification of at least one network resource associated with the at least one portion of the at least one search term by the client device from the at least one server and prior to sending a request to furnish a one of the at least one network resource associated with the at least one portion of the at least one search term by the client device to the at least one server, displaying the identification of the at least one network resource associated with the at least one portion of the at least one search term in a drop-down box associated with the search bar on the display of the client device.

21. The non-transient computer information storage medium of claim 20, wherein the information storage medium further stores instructions that when executed by the computer processor effect, along with displaying the identification of the at least one network resource associated with the at least one portion of the at least one search term in a drop-down box associated with the search bar on the display of the client device, displaying at least one suggested search query in respect of the at least one portion of the at least one search term in the drop-down box on the display of the client device.

22. The non-transient computer information storage medium of claim 21, wherein the identification of the at least one network resource associated with the at least one portion of the at least one search term is displayed first in the drop-down box on the display of the client device.

23. The non-transient computer information storage medium of any one of claims 19 to 22, wherein the search bar is a multi-function bar.

24. The non-transient computer information storage medium of claims 19 to 23, wherein the search bar is part of a browser.

25. The non-transient computer information storage medium of any one of claims 19 to 24, wherein the information storage medium further stores instructions that when executed by the computer processor effect, after receiving identification of at least one network resource associated with the at least one portion of the at least one search term by the client device from the at least one server and prior to sending a request to retrieve a one of the at least one network resource associated with the at least one portion of the at least one search term by the client device to the at least one server,
sending an additional portion of the at least one search term by the client device to the at least one server; and
receiving identification of at least one network resource associated with both the additional portion of and the at least one portion of the at least one search term by the client device from the at least one server; and
wherein:
sending a request to furnish a one of the at least one network resource associated with the at least one portion of the at least one search term by the client device to the at least one server, is, sending a request to furnish a one of the at least one network resource associated with both the additional portion of and the at least one portion of the at least one search term by the client device to the at least one server; and
receiving the one of the at least one network resource associated with the at least one portion of the at least one search term by the client device from the at least one server, is, receiving of the one of the at least one network resource associated with both the additional portion and the at least one portion of the at least one search term by the client device from the at least one server.

26. A method of furnishing a user of a client device having a user interface including a display displaying a search bar, with a network resource, the method comprising:
receiving at least a portion of at least one search term having been entered in the search bar, by at least one server from the client device;
sending identification of at least one network resource associated with the at least one portion of the at least one search term by the at least one server to the client device;
receiving a request to furnish a one of the at least one network resource associated with at least one portion of the at least one search term by the least one server from the client device; and
sending the one of the at least one network resource associated with the at least one portion of the at least one search term by the at least one the server to the client device;
all prior to the at least one server having received a request for a search in respect of the at least one portion of the at least one search term.

27. The method of claim 26, the method further comprising, after receiving at least a portion of at least one search term having been entered in the search bar of the browser by the at least one server from the client device and prior to sending identification of at least one network resource associated with the at least one portion of the at least one search term by the at least one server to the client device, retrieving the indication of the at least one network resource associated with the at least one portion of the at least one search term from a database operationally connected with the at least one server.

28. The method of claim 27, wherein the at least one network resource associated with the at least one portion of the least one search term has been determined based on an analysis of previous network resources having been selected by users having requested searches including the at least one portion of the at least one search term.

29. The method of any one of claims 26 to 28, wherein the identification of the at least one network resource associated with the at least one portion of the at least one search term includes a uniform resource locator (URL) of the at least one network resource.

30. The method of claim 29, wherein the URL of the at least one network resource does not include the at least one portion of the at least one search term.

31. The method of any one of claims 26 to 30, wherein the identification of the at least one network resource associated with the at least one portion of the at least one search term includes a title of the at least one network resource.

32. The method of claim 31, wherein the title of the at least network resource does not include the at least one portion of the at least one search term.

33. The method of any one of claims 26 to 32, wherein the search bar is a multi-function bar.

34. The method of any one of claims 26 to 33, wherein the search bar is part of a browser.

35. The method of any one of claims 26 to 34, further comprising, after sending identification of at least one network resource associated with the at least one portion of the at least one search term by the at least one server to the client device and prior receiving a request to furnish a one of the at least one network resource associated with at least one portion of the at least one search term by the least one server from the client device,
receiving an additional portion of the at least one search term by the at least one server from the client device; and
sending identification of at least one network resource associated with both the additional portion of and the at least one portion of the at least one search term by the at least one server to the client device; and
wherein:
receiving a request to furnish a one of the at least one network resource associated with the least one portion of the at least one search term , by the least one server from the client device, is, receiving a request to furnish a one of the at least one network resource associated with both the additional portion of and the least one portion of the at least one search term by the least one server from the client device; and
sending the one of the at least one network resource associated with the at least one portion of the at least one search term by the at least one the server to the client device, is, sending the one of the at least one network resource associated with both the additional portion of and the at least one portion of the at least one search term by the at least one the server to the client device.

36. A system for furnishing a user of a client device having a user interface including a display displaying a search bar, with a network resource, the system comprising at least one server, the at least one server including:
a computer processor;
a communications interface operationally connected with the computer processor and structured to communicate with the client device;
a non-transient computer information storage medium operationally connected with the computer processor, the information storage medium storing instructions that when executed by the computer processor effect:
receiving at least a portion of at least one search term having been entered in the search bar by the at least one server from the client device;
sending identification of at least one network resource associated with the at least one portion of the at least one search term by the at least one server to the client device;
receiving a request to furnish a one of the at least one network resource associated with at least one portion of the at least one search term by the at least one server from the client device; and
sending the one of the at least one network resource associated with the at least one portion of the at least one search term by the at least one the server to the client device;
all prior to the at least one server having received a request for a search in respect of the at least one portion of the at least one search term.

37. The system of claim 36, wherein the information storage medium further stores instructions that when executed by the computer processor effect, after receiving at least a portion of at least one search term having been entered in the search bar by the at least one server from the client device and prior to a sending identification of at least one network resource associated with the at least one portion of the at least one search term by the at least one server to the client device, retrieving the indication of the at least one network resource associated with the at least one portion of the at least one search term from a database operationally connected with the at least one server.

38. The system of claim 37, wherein the at least one network resource associated with the at least one portion of the at least one search term has been determined based on an analysis of previous network resources having been selected by users having requested searches including the at least one portion of the at least one search term.

39. The system of any one of claims 36 to 38, wherein the identification of the at least one network resource associated with the at least one portion of the at least one search term includes a uniform resource locator (URL) of the at least one network resource.

40. The system of claim 39, wherein the URL of the at least one network resource does not include the at least one portion of the at least one search term.

41. The system of any one of claims 36 to 40, wherein the identification of the at least one network resource associated with the at least one portion of the at least one search term includes a title of the at least one network resource.

42. The system of claim 41, wherein the title of the at least network resource does not include the at least one portion of the at least one search term.

43. The system of any one of claims 36 to 42, wherein the search bar is a multi-function bar.

44. The system of any one of claims 36 to 43, wherein the search bar is part of a browser.

45. The system of any one of claims 36 to 44, wherein the information storage medium further stores instructions that when executed by the computer processor effect, after sending identification of at least one network resource associated with the at least one portion of the at least one search term by the at least one server to the client device and prior to a receiving a request to furnish a one of the at least one network resource associated with at least one portion of the at least one search term by the least one server from the client device,
receiving an additional portion of the at least one search term by the at least one server from the client device; and
sending identification of at least one network resource associated with both the additional portion of and the at least one portion of the at least one search term by the at least one server to the client device; and
wherein:
receiving a request to furnish a one of the at least one network resource associated with at least one portion of the at least one search term by the at least one server from the client device, is, a receiving a request to furnish a one of the at least one network resource associated with both the additional portion of and the at least one portion of the at least one search term by the least one server from the client device; and
sending the one of the at least one network resource associated with the at least one portion of the at least one search term by the at least one the server to the client device, is, sending the one of the at least one network resource associated with both the additional portion of and the at least one portion of the at least one search term by the at least one the server to the client device.

46. A non-transient computer information storage medium storing instructions that when executed by a computer processor of at least one server effect:
receiving at least a portion of at least one search term having been entered in a search bar displayed on a display of a user interface of a client device by the at least one server from a client device;
sending identification of at least one network resource associated with the at least one portion of the at least one search term by the at least one server to the client device;
receiving a request to furnish a one of the at least one network resource associated with at least one portion of the at least one search term by the at least one server from the client device; and
sending the one of the at least one network resource associated with the at least one portion of the at least one search term by the at least one the server to the client device;
all prior to the at least one server having received a request for a search in respect of the at least one portion of the at least one search term.

47. The non-transient computer information storage medium of claim 46, wherein the information storage medium further stores instructions that when executed by the computer processor effect, after receiving at least a portion of at least one search term having been entered in the search bar by the at least one server from the client device and prior to sending of identification at least one network resource associated with the at least one portion of the at least one search term by the at least one server to the client device, retrieving the indication of the at least one network resource associated with the at least one portion of the at least one search term from a database operationally connected with the at least one server.

48. The non-transient computer information storage medium of claim 47, wherein the at least one network resource associated with the at least one portion of the at least one search term has been determined based on an analysis of previous network resources having been selected by users having requested searches including the at least one portion of the at least one search term.

49. The non-transient computer information storage medium of any one of claims 46 to 48, wherein the identification of the at least one network resource associated with the at least one portion of the at least one search term includes a uniform resource locator (URL) of the at least one network resource.

50. The non-transient computer information storage medium of claim 49, wherein the URL of the at least one network resource does not include the at least one portion of the at least one search term.

51. The non-transient computer information storage medium of any one of claims 46 to 50, wherein the identification of the at least one network resource associated with the at least one portion of the at least one search term includes a title of the at least one network resource.

52. The non-transient computer information storage medium of claim 51, wherein the title of the at least network resource does not include the at least one portion of the at least one search term.

53. The non-transient computer information storage medium of any one of claims 46 to 52, wherein the search bar is a multi-function bar.

54. The non-transient computer information storage medium of any one of claims 46 to 53, wherein the search bar is part of a browser.

55. The non-transient computer information storage medium of any one of claims 46 to 54, wherein the information storage medium further stores instructions that when executed by the computer processor effect, after sending identification of at least one network resource associated with the at least one portion of the at least one search term by the at least one server to the client device and prior to a receiving a request to furnish a one of the at least one network resource associated with at least one portion of the at least one search term by the least one server from the client device,
receiving an additional portion of the at least one search term by the at least one server from the client device; and
sending identification of at least one network resource associated with both the additional portion of and the at least one portion of the at least one search term by the at least one server to the client device; and
wherein:
receiving a request to furnish a one of the at least one network resource associated with at least one portion of the at least one search term by the least one server from the client device, is, receiving a request to furnish a one of the at least one network resource associated with both the additional portion of and the at least one portion of the at least one search term by the least one server from the client device; and
sending the one of the at least one network resource associated with the at least one portion of the at least one search term by the at least one the server to the client device, is, sending, of the one of the at least one network resource associated with both the additional portion of and the at least one portion of the at least one search term by the at least one the server to the client device.
